(19) United States
(12) Patent Application Publication
(10) Pub. No.: US 2011/0137689 A1
(43) Pub. Date: Jun. 9, 2011

(54) ENHANCED LOCAL AND SOCIAL SERVICES FOR ATM BANKING MACHINES

(75) Inventors: Sandra Jean Valentino Chua, Toronto (CA); Michael Muller, Medford, MA (US)

(73) Assignee: International Business Machines Corporation, Armonk, NY (US)

(21) Appl. No.: 12/630,269

(22) Filed: Dec. 3, 2009

(51) Int. Cl. G06Q 50/00; G06Q 40/00; G06Q 30/00

(52) U.S. Cl. 705/5; 705/43; 705/319; 705/27.1

(57) ABSTRACT

Automated teller machine in banking has user-interactive interface. The user interface provides both banking functions and social functions. The social functions include interactive information regarding location-based services and events, and include social networking services. Operations of the social functions include making restaurant reservations, purchasing show or game tickets and chatting with other bank customers at a respective ATM. The bank may generate revenue from local area services advertising on ATM's and from supporting customer-user chat sessions.

### BACKGROUND

The present invention relates to certain computer networks, and more specifically, to Automated Teller Machines.

Bank ATMs (Automated Teller Machines) are commonly used for simple financial transactions between a single user and the bank. The typical user interface of such ATM's include capabilities to make a deposit, make a withdrawal and/or check account balances.

### BRIEF SUMMARY

The present invention expands the prior capabilities of bank ATM's in at least two ways:

by adding local services to the menu of options, and

by adding social-networking to the menu of options.

According to one embodiment of the present invention, a computer method, system and/or apparatus provides an Automated Teller Machine (ATM) configured for global computer network (e.g., the internet) communications. The ATM employs a user interface that provides both banking functions and social functions, for example side by side or otherwise accessible in various screen views. The social functions include (a) user interactive information on local area (or location based) events, services and/or businesses and the like, and (b) social networking of bank customers. The bank may charge fees in connection with these functions.

Local area events may include arts and entertainment shows such as live theatre shows, film viewings or cinema showings. Local area events may also include spectator sports game events. The user interface enables a user of the ATM to make show or game event reservations, and/or purchase tickets to a show/game. The ATM can print hardcopy of purchased tickets as well as discount coupons, promotional material and the like for various local area events and services.

Local area services may include neighborhood restaurants, clubs and businesses. The user interface enables a user of the ATM to make reservations at a restaurant, club or business of the user's choosing. The user interface may enable the user to view a restaurant menu on the ATM display upon user command/request.

The social functions of the user interface may indicate to a user during use of the ATM that a friend (as defined in a computerized social network e.g., at the bank, internet-mediated or similar and/or combinations thereof) has recently used a nearby ATM. Further in some embodiments, the social functions may include enabling a chat session between such friends through respective ATMs.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network in which embodiments of the present invention operate.

FIG. 2 is a block diagram of a computer node in the network of FIG. 1.

FIGS. 3a and 3b are, respectively, a schematic view and a flow diagram of a user interface in one embodiment of the present invention.

### DETAILED DESCRIPTION

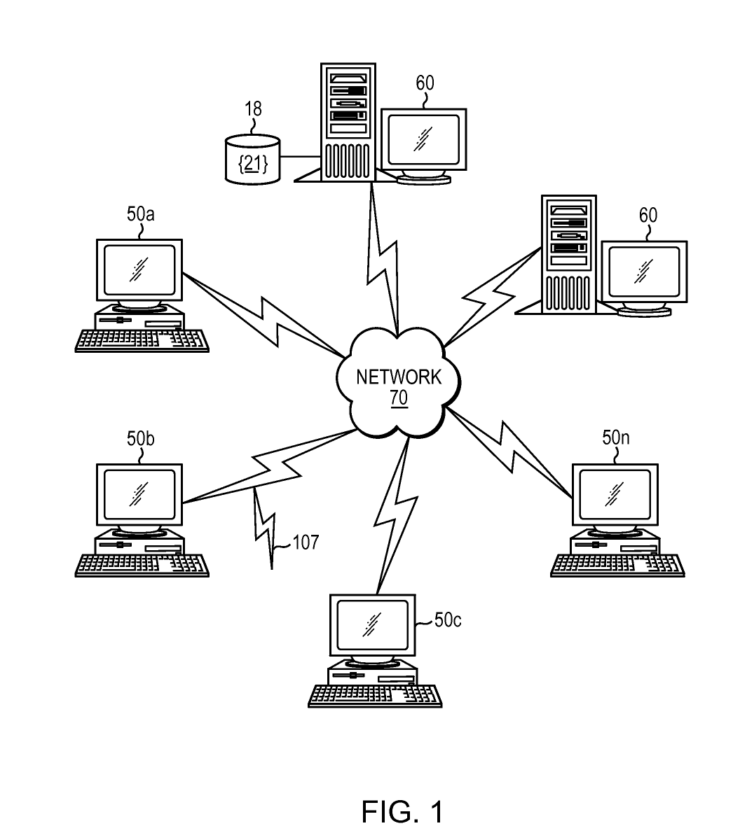

FIG. 1 illustrates a computer network or similar digital processing environment in which the present invention may be implemented.

Client computer(s)/devices 50 and server computer(s) 60 of a bank provide processing, storage, and input/output devices executing application programs and the like. Client computer(s)/devices 50 can also be linked through communications network 70 to other computing devices, including other client devices/processes 50 and server computer(s) 60. Client computers/devices 50 include Automated Teller Machines (ATMs). Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

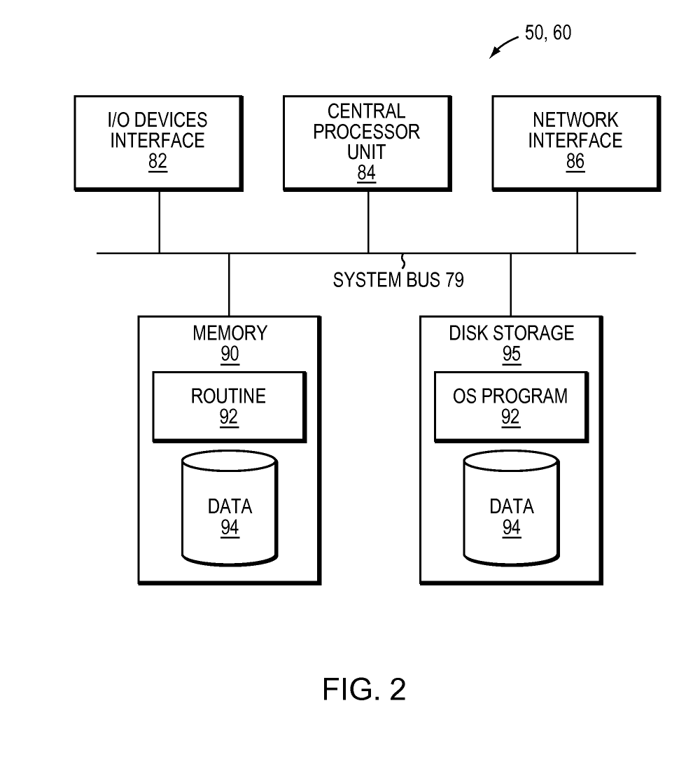

FIG. 2 is a diagram of the internal structure of a computer (e.g., client processor/ATM 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., user interface 20, social functions 31, 33 and user-interactive advertisements 35 and supporting code detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

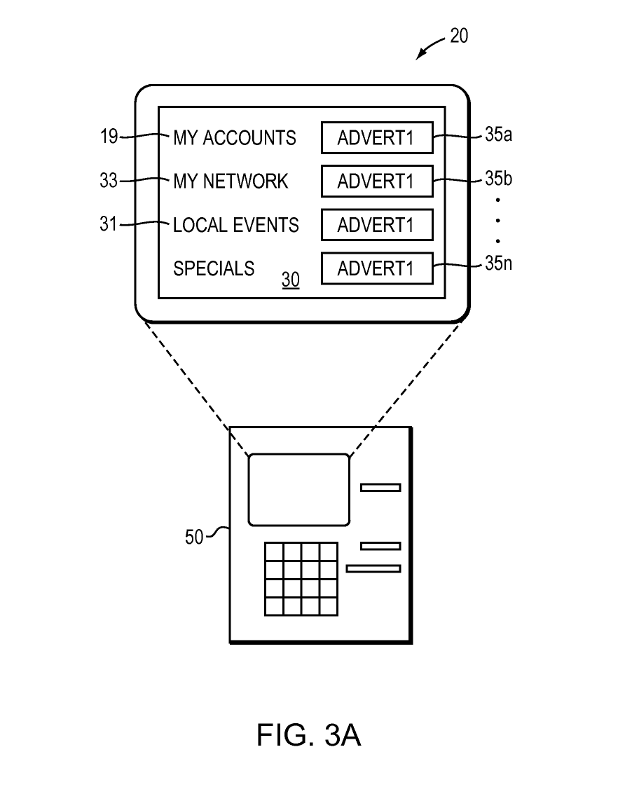

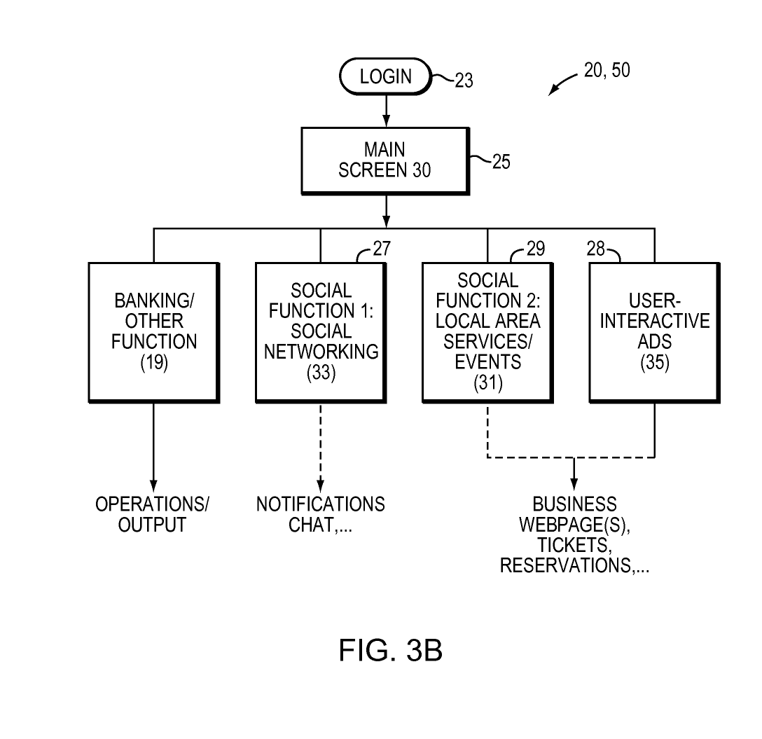

In addition to conventional bank ATM operations and features, the present invention enhances ATM's 50 with location-based services and social-networking type services. These two areas of enhancement are implemented by user interactive advertisements 35a, b . . . n (generally 35) and social functions 31, 33 added to the ATM user interface 20 as follows and illustrated in FIG. 3a.

In embodiments, the location-based services may include advertisements 35 for nearby businesses (which pay the bank to advertise). The terms “nearby”, “neighborhood” or “local area” businesses are with respect to the location of the subject ATM 50, and thus different businesses may advertise on different ATM's based on relative location. The advertisements 35 are preferably user interactive. The greater the interactivity enabled the higher the bank advertising charges may be in some embodiments. The different levels of interactivity may provide different abilities, such as:

ability to display, upon user request, additional detail for a user selected business; and

the ability to perform further operations, transactions and the like with the corresponding business in response to user command/input.

For example, a local restaurant may advertise in the ATM user interface 20 with a user-interactive advertisement 35. Upon user request, such as selection of the displayed advertisement 35 for the restaurant, the user interactive interface 20/ATM 50 displays the current day's menu of the user-selected restaurant. Upon further user interaction with the user interface 20 screen view, the ATM 50 may enable the user to place a reservation. The restaurant (advertising business) may pay any online reservation fee or other associated fee.

In another example, a neighborhood theatre may have an advertisement 35 in the ATM user interface 20. Upon user selection of this advertisement 35, the user interface system 20/ATM 50 displays a schedule of shows or showings. Upon further interaction by the user, the ATM 50 enables ticketing (i.e., ticket or seat reservation and ticket purchase) for a user selected show including user-selected seating, user-defined number of seats/tickets and so forth. The ATM 50 prints tickets via its receipt printer. The theatre may pay the ticketing fee in one embodiment; the user may pay some of the ticketing fee in other embodiments.

In embodiments, the ATM user interface 20 may display discount coupons during the interactive advertisement 35. The ATM 50 allows the user to print hardcopy of a coupon via the receipt printer. Other alternatives for the user to receive coupons, promotions or similar communications through user interface 20 are suitable.

With respect to social networking type services, embodiments of the present invention store, in advance, a list of friends of the user. Each of the listed friends also have respective accounts at the bank in common with the user. This listing of bank customer friends may be accomplished as follows. In setting up a bank customer as a user of the ATM 50, the customer is assigned a user name. The user name is associated with respective bank accounts that the customer has with the bank. The bank/ATM system 50 may offer the customer to set certain security settings (e.g., password, pin, etc.), to set certain preferences for display options, and so forth. In addition, according to the present invention, the bank/ATM 50 allows the customer-user to indicate names of other customers of the bank as friends. Categorizing groups of customer-users as “friends” forms a computerized social network 21 in bank servers 60. That is, server 60 stores in a database 18 the customer indicated list of names of other customers of the bank and stores indications of relative social relationships of bank customers. Database 18 effectively implements the computerized social network 21 of bank customers and supports the social networking services 33 of the present invention.

In other embodiments, bank servers 60 and ATM's 50 access social-networking information via conventional internet social networking sites, such as Facebook, My Space or LinkedIn. The requisite data (friends, user's relationships) are available using public API's (application program interfaces) at such sites. Further the bank provides bank customer user's with the option to allow such ATM access to prior-established user information from third-party social networking sites.

In accordance with the invention social networking services 33, while one user is using an ATM 50, the ATM user interface 20 notifies that user when a friend (from the pre-stored list in 18) has used a nearby ATM 50 during the same time period. To support this, database 18 may log indications of customer-user ATM activity including location of ATM used, date/time used, start time/end time of use and so on per customer-user. Then when a user is using an ATM, social networking services function 33 may look up in database 18 related friends' ATM usage log entries and determine whether to notify the user of any friend's recent ATM usage.

Further, in some embodiments, the social networking functions 33 of user interface 20 may offer to open a chat session if the two bank customers (users) are using two nearby ATM's 50 at the same time. For chats longer than a pre-set maximum (threshold) session duration, the bank may charge a fee to the bank accounts of the users for the chat. Other fee structures are suitable.

By way of non-limiting example, a user interface 20 of an ATM 50 embodying the present invention is illustrated in FIGS. 3a and 3b. The user interface 20 is generally formed of a series of screen views, some are served (by bank server 60 for example) as Web pages or similar transmitted pages. The contents on a displayed screen/page are generated or otherwise supported by HTML (HyperText Markup Language) or similar markup language code and by Java Script or similar dynamic language code for forming page objects (images, animation, audio, links, etc.) on the fly.

After an initial login or initialization step 23 (FIG. 3b), user interface 20/ATM 50 displays a main screen view (or home page or the like) 30. The main screen 30 in one embodiment as illustrated in FIG. 3a provides user options of banking and other bank related functions (“My accounts”) 19 and the invention social functions 31, 33. Upon user selection of the social function labeled “Local events” 31, user interface 20 (at step 29, FIG. 3b) generates the series of screen views/pages advertising local area businesses, such as those described above. In particular, hyperlinks corresponding to user selected item (business name, displayed options, etc.) displayed on a page/screen view are employed. The ATM 50 and bank server 60 in response serve/generate and display the hyperlinked page through user interface 20.

Upon user selection of the social function labeled “My network” 33, user interface 20 (step 27) generates the pertinent screen views/pages having notifications of friends recently logged on to other ATM's 50 of the bank and offering chat sessions and so on. Common notifier technology, chat technology, and similar global computer network communication techniques are utilized. Calls to internet-mediated social-networking sites and the like may be used.

Other features for these social functions 31, 33 are suitable and within the purview of one skilled in the art.

The main screen 30 and/or other screen views may display various user-interactive advertisements 35 as well. For example, user-interactive advertisements 35 may be displayed in combination with, in addition to and/or separate from the screen views/pages of offered functions 19, 31, 33. This is accomplished using common hypertext technology (e.g., hyperlinks to corresponding business website/web pages), XML code, ATOM-based Web calls, REST architecture and the like is employed. Upon user selection of such a displayed advertisement 35, ATM user interface 20 (step 28) displays to the user the associated (linked) further information. If the advertisement 35 is for example a local area restaurant, then the associated further information displayed upon user selection may be the current day's menu for the restaurant. Known technology for making online reservations and ticket purchasing supports operations of pages displayed by steps 28 and 29.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer method of banking comprising:
providing an automated teller machine (ATM) configured for global computer network communication; and
deploying a user interface on the automated teller machine that provides banking functions and social functions, wherein the social functions include social networking of bank customers by forming a respective computerized social network of friends who have a bank in common, and indicating to a user during use of the ATM that a friend in the user's computerized social network has recently used a nearby ATM, said indicating being a notification independent of the user and friend initiating a message between each other.

2. A computer method as claimed in claim 1 wherein the global computer network is the Internet.

3. A computer method as claimed in claim 1 wherein the social functions include user interactive information on local area events.

4. A computer method as claimed in claim 3 wherein the local area events include:
arts and entertainment show events, and
spectator game events; and
the user interface enables a user of the ATM to reserve or purchase any of show tickets and game tickets.

5. A computer method as claimed in claim 4 wherein the user interface prints hardcopy of purchased tickets through the ATM.

6. A computer method as claimed in claim 1 wherein the social functions include user interactive information regarding location based services.

7. A computer method as claimed in claim 6 wherein the location based services include neighborhood restaurants, clubs and businesses.

8. A computer method as claimed in claim 7 wherein the user interface enables a user of the ATM to make a reservation at a user selected restaurant, club or business.

9. A computer method as claimed in claim 1 wherein the user interface enables a user to view a restaurant menu on the ATM upon user command.

10. A computer method as claimed in claim 1 wherein the user interface enables a user to receive a coupon or promotional communication.

11. A computer method as claimed in claim 1 wherein the social functions include social networking of bank customers by calling internet-mediated social networking sites.

12. (canceled)

13. A computer method as claimed in claim 1 wherein the social functions include enabling a chat session between the friend and user through respective ATMs.

14. A computer banking system comprising:
an automated teller machine (ATM) configured for global computer network communication; and
a user interface deployed on the ATM providing banking functions and social functions, wherein the social functions include social networking of bank customers by forming a respective computerized social network of friends who have a bank in common, and indicating to a user during use of the ATM that a friend in the user's computerized social network has recently used a nearby ATM, said indicating being a notification independent of the user and friend initiating a message between each other.

15. A computer system as claimed in claim 14 wherein the global computer network is the Internet.

16. A computer system as claimed in claim 14 wherein the social functions include user interactive information on local area events.

17. A computer system as claimed in claim 16 wherein the local area events include:
arts and entertainment show events, and
spectator game events; and
the user interface enables a user of the ATM to reserve or purchase any of show tickets and game tickets.

18. A computer system as claimed in claim 17 wherein the user interface prints hardcopy of purchased tickets through the ATM.

19. A computer system as claimed in claim 14 wherein the social functions include user interactive information regarding location-based services; and
the location-based services include any of restaurants, clubs and businesses.

20. A computer system as claimed in claim 19 wherein the user interface enables a user of the ATM to make a reservation at a user selected restaurant, club or business.

21. A computer system as claimed in claim 14 wherein the user interface enables a user to view a restaurant menu on the ATM upon user command.

22. A computer system as claimed in claim 14 wherein the social functions include social networking of bank customers by calling an internet-mediated social networking site.

23. (canceled)

24. A computer system as claimed in claim 22 wherein the social functions include enabling a chat session between bank customers through respective ATMs.

25. A computer program product for automated banking, the computer program product comprising:
a computer readable storage medium having computer readable program code embodied therewith, the computer readable program code comprising computer readable program code configured to:
enable an automated teller machine (ATM) to have global computer network communications; and
deploy a user interactive interface on the ATM which provides to a user both banking functions and social functions, the social functions including computer based social networking of bank customers by (i) forming a respective computerized social network of friends who have a bank in common, and (ii) indicating to a user during use of the ATM that a friend in the user's computerized social network has recently used a nearby ATM, said indicating being a notification independent of the user and friend initiating a message between each other.
